(19) United States
(12) Patent Application Publication
(10) Pub. No.: US 2016/0053517 A1
(43) Pub. Date: Feb. 25, 2016

(54) TOGGLE SENSOR AND APPLICATIONS FOR TOGGLE SENSOR

(71) Applicant: MAGNA CLOSURES INC., NEWMARKET (CA)

(72) Inventor: KRIS TOMASZEWSKI, NEWMARKET (CA)

(21) Appl. No.: 14/830,161

(22) Filed: Aug. 19, 2015

Related U.S. Application Data
(60) Provisional application No. 62/041,351, filed on Aug. 25, 2014.

(51) Int. Cl. E05B 81/74; H01H 3/42; E05B 77/26

(52) U.S. Cl. CPC E05B 81/74; E05B 77/26; H01H 3/42

(57) ABSTRACT

A sensor assembly which can be used in a power actuated child lock system includes a resilient sensor arm which functions as both a switch and spring to bias a switch cam to a desired position. The sensor arm extends from a base unit containing a plunger, and the sensor arm extends over the plunger to a distal end. A motor drives the switch cam to a desired position along the sensor arm, and the sensor arm biases the switch cam to maintain the switch cam in that desired position. When the switch cam engages a first segment of the sensor arm, the switch cam presses the sensor arm and plunger, which is referred to as an unlocking position. When the switch cam is moved to a second segment of the sensor arm, the switch cam releases the sensor arm and plunger, referred to as a locking position.

### CROSS REFERENCE TO RELATED APPLICATION

This U.S. patent application claims the benefit of U.S. provisional patent application Ser. No. 62/041,351, filed Aug. 25, 2014, the entire content of which is incorporated herein by reference.

### BACKGROUND

1. Field of the Invention

This invention relates generally to switches and sensors for detecting the position of a component, and more specifically to such switches having a biasing member operable for positively locating the component in the desired position, for example switches and sensors of power actuated child lock systems.

2. Related Art

Power actuated systems oftentimes include a switch or sensor for detecting whether a component, such as a switch cam, is in a first position or a second position. Typically, the switch cam is biased by a separate component, such as a toggle spring, to positively locate the switch cam in either the first or second position.

For example, International Application Publication No. WO 2009/030046 discloses a power actuated child lock system for an automotive vehicle including a sensor indicating whether a child lock lever is in an unlocking position or locking position. The sensor includes a base unit with an outwardly extending plunger. The sensor also includes a cantilevered and planar sensor arm which extends from the base unit to a distal end. In the locking position, the sensor arm is disposed at an angle relative to the base unit and does not engage the plunger. In the unlocking position, the sensor arm is pressed against the plunger. The depressed plunger indicates to the sensor that the child lock lever is in the unlocking position, and the undepressed or released plunger indicates that the child lock lever is in the locking position. In response to the depressed or released plunger, the sensor informs a controller of the vehicle that the child lock lever is in the locking or unlocking position, and the controller responds by activating or deactivating the child lock of the automotive vehicle.

It is important that the component engaging the sensor arm stays in the desired position, either the child locking position or unlocking position, so that the plunger is not unintentionally depressed or released, in which case the sensor could incorrectly inform the controller to activate or deactivate the child lock. Thus, the system typically includes a biasing component, for example a toggle spring, to bias the component engaging the sensor arm toward either the locking position or the unlocking position, and preferably preventing the component from slipping out of the desired position.

### SUMMARY

A first aspect provides a sensor assembly including an improved sensor arm which functions as a switch and also biases a component, such as a switch cam or lever, to a desired position. Thus, the sensor arm can replace the switch and separate toggle spring used in comparative systems. The sensor assembly also includes a base unit containing an activator, such as a plunger. The activator extends outwardly from the base unit and is movable relative to the base unit. The sensor arm is formed of a resilient material and extends from the base unit to a distal end. The sensor arm includes a first segment extending from the distal end over the outwardly extending activator, and a second segment extending from the first segment to the base unit. The switch cam engages the sensor arm and is movable along the sensor arm between the first segment and the second segment. The switch cam presses the sensor arm and the activator to a depressed position when the switch cam engages the first segment, and the switch cam allows the first segment and the activator to move to a released position when the switch cam engages the second segment.

Another aspect provides a power actuated lock system including the sensor assembly described above. The power actuated lock system also includes a motor for moving the switch cam along the sensor arm from one of the segments to the other segment.

Yet another aspect provides a child lock system for a vehicle including the sensor assembly and the motor. An electronics unit is disposed in the base unit and in communication with the activator. The electronics unit detects the position of the switch cam based on the position of the activator and conveys the position of the switch cam to a controller. The controller then activates or deactivates a child lock in response to the position of the switch cam conveyed to the controller by the electronics unit.

Other aspects will be evident from the following drawings and further description.

### BRIEF DESCRIPTION OF THE DRAWINGS

Other advantages of the present embodiments will be readily appreciated, as the same becomes better understood by reference to the following detailed description when considered in connection with the accompanying drawings wherein:

FIG. 1 is a top view of an example power actuated child lock system including an example sensor assembly with a switch cam in an unlocking position and a child lock in a non-activated position;

FIG. 1A is an enlarged view of the sensor of FIG. 1;

FIGS. 2 and 3 are bottom views of the child lock system of FIG. 1;

FIG. 4 is a top view of the child lock system of FIG. 1 with the switch cam in a child locking position and the child lock in an activated position;

FIGS. 5 and 6 are bottom views of the child lock system of FIG. 4;

FIG. 7 is a top view of a comparative child lock system including a toggle spring with a switch cam in an unlocking position and a child lock in a non-activated position;

FIG. 8 is a bottom view of the comparative child lock system of FIG. 7;

FIG. 9 is a top view of the comparative child lock system of FIG. 7 with the switch cam in a child locking position and a child lock in an activated position; and

FIGS. 10 and 11 are bottom views of the comparative child lock system of FIG. 9.

### DETAILED DESCRIPTION OF EXAMPLE EMBODIMENTS

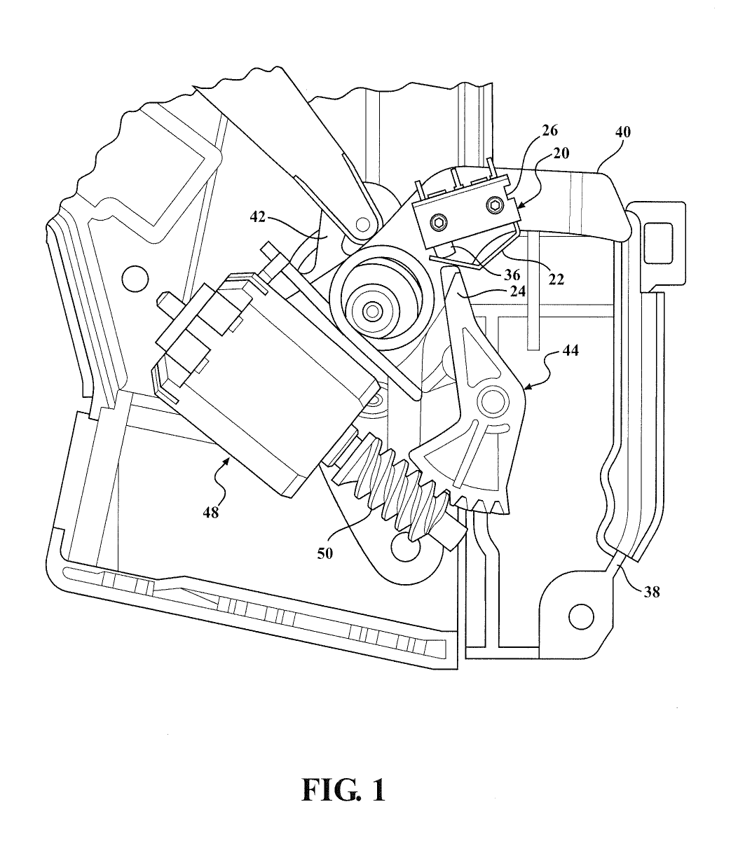

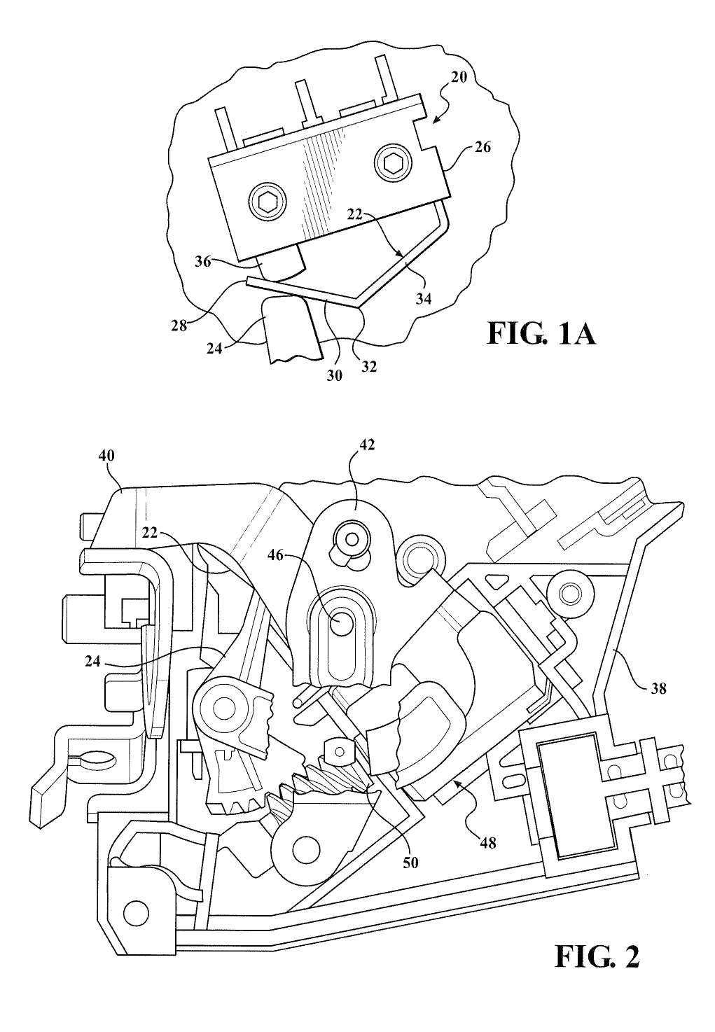

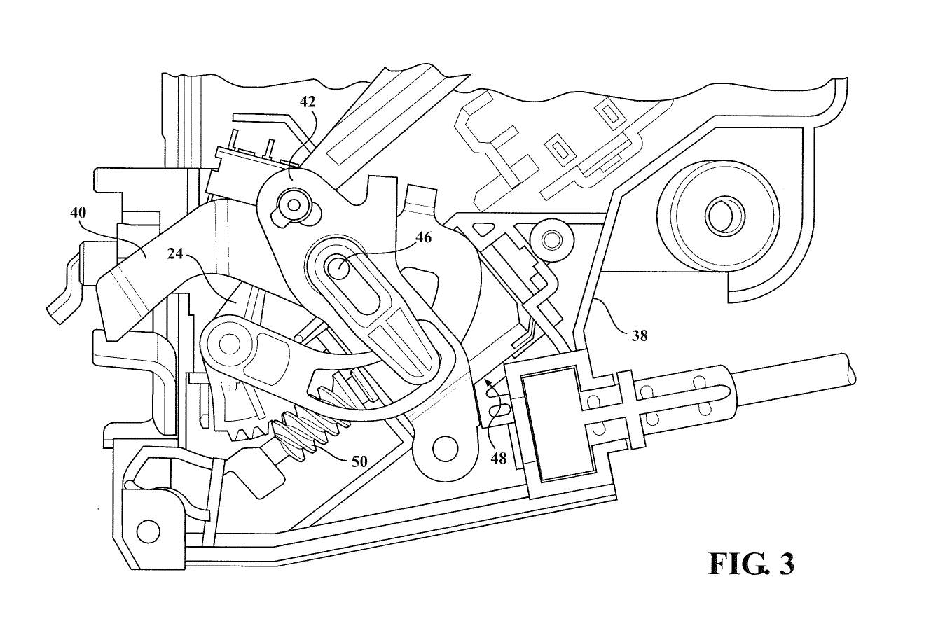

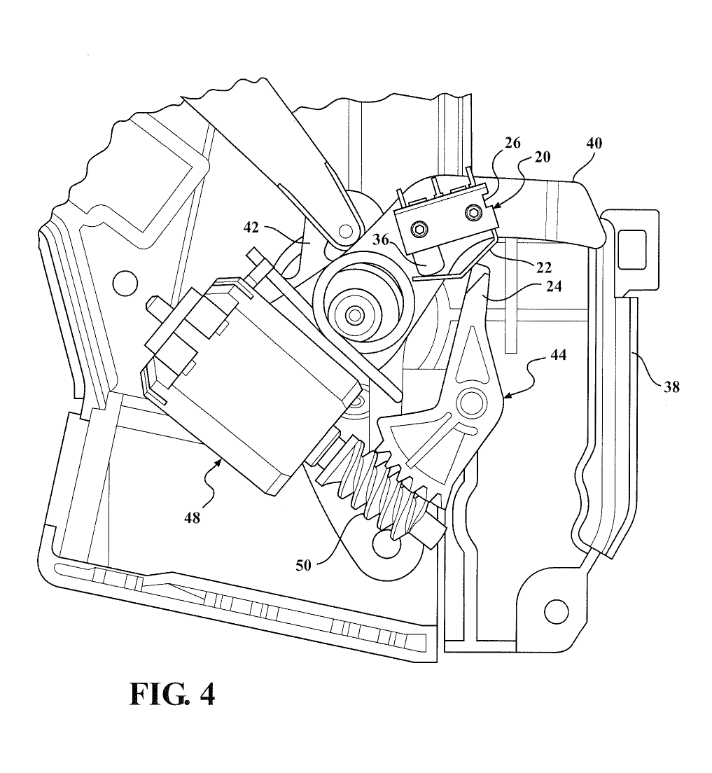

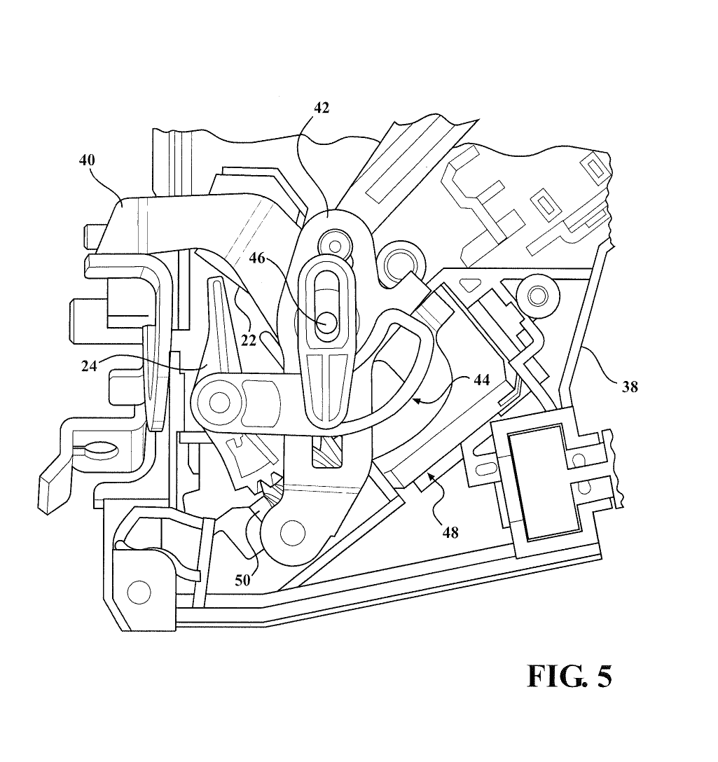

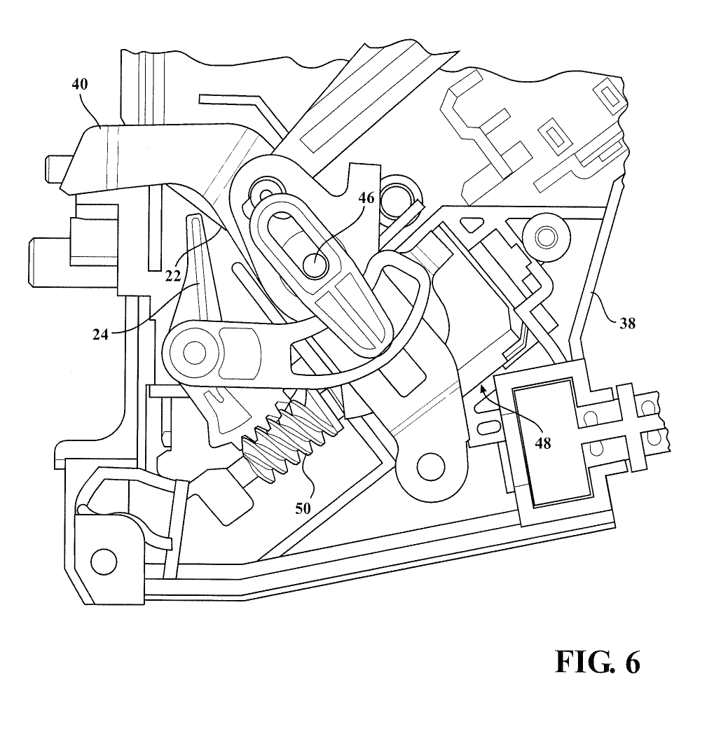

A sensor assembly 20, also referred to as a switch or toggle sensor assembly, includes an improved sensor arm 22 for biasing a switch cam 24 toward a first position or a second position and reliably maintaining the switch cam 24 in the desired position. FIGS. 1-6 illustrate an example of the sensor assembly 20 in a child lock system. FIGS. 1-3 show the switch cam 24 of the example child lock system in the first position, also referred to as a depressed position. In this case, the depressed position is an unlocking position. FIGS. 4-6 show the switch cam 24 in the second position, also referred to as a released position, which in this case is a child locking position. In the example embodiment, the switch cam 24 pivots about an axis, but movement of the cam 24 could be in any direction, including radial or axial. One of ordinary skill in the art will understand that the first position could alternatively be a child locking position and the second position could alternatively be an unlocking position. One of ordinary skill in the art will also understand that the sensor assembly 20 with the improved sensor arm 22 could be used in any other type of latch application or even non-latch applications, wherein a component moves from a first position to a second position or vice versa.

As best shown in FIG. 1A, the sensor assembly 20 of the example embodiment comprises a normally closed (NC) switch with a base unit 26 containing an electronics unit and optional memory. The improved sensor arm 22 is formed of a resilient material and extends from the base unit 26 to a distal end 28. The sensor arm 22 includes a first segment 30 extending from the distal end 28 away from the base unit 26 to an apex 32, and a second segment 34 extending from the apex 32 back towards the base unit 26. When the switch cam 24 is in the first position, the cam 24 engages the first segment 30 of the sensor arm 22. When the cam 24 is moved from the first position to the second position, the cam 24 presses the sensor arm 22 toward the base unit 26 as it travels over the apex 32 to the second segment 34, and releases the pressure on the first segment 30 once disposed along the second segment 34.

The design of the sensor arm 22 and the resilient material used to form the sensor arm 22 allow the sensor arm 22 to function as a leaf spring or toggle spring. In other words, the sensor arm 22 acts as its own return spring. In the example embodiment shown in the Figures, the first and second segments 30, 34 of the sensor arm 22 are straight. Alternatively, the first and second segments 30, 34 could be curved from the base unit 26 to the distal end 28. The sensor arm 22 is designed to bias the switch cam 24 to remain in the desired position. For example, the sensor arm 22 reliable maintains the switch cam 24 along the first segment 30 after the switch cam 24 is moved to the first segment 30, and reliably maintains the switch cam 24 along the second segment 34 after the switch cam 24 is moved to the second segment 34. The spring rate and load permitted by the sensor arm 22 can be adjusted by changing the stiffness and dimensions of the resilient spring material.

The sensor assembly 20 also includes an activator 36, for example a plunger, disposed in the base unit 26, with a portion of the activator 36 extending outwardly of the base unit 26 between the sensor arm 22 and the base unit 26. When the switch cam 24 is disposed in the first position against the first segment 30, the cam 24 presses the first segment 30 of the sensor arm 22 into the activator 36, such that the activator 36 is depressed into the base unit 26. When the cam 24 is moved to the second position, the first segment 30 releases the pressure on the activator 36 such that the activator 36 is not depressed into the base unit 26. The activator 36 includes a return spring (not shown) inside of the base unit 26 for releasing the activator 36 when the cam 24 moves from the first position to the second position. Although the activator 36 of the example sensor assembly 20 is a plunger, the system could include another component in place of the plunger for being activated by the sensor arm 22 when the cam 24 is disposed in the first position.

In the example embodiment, when the activator 36 is depressed into the base unit 26 by the sensor arm 22, the sensor assembly 20 makes and/or breaks electrical contact with electronic components in the base unit 26 to detect that the cam 24 is in the first position. Whether the sensor assembly 20 makes and/or breaks electrical contact will depend on the type of sensor assembly 20, such as if the sensor assembly 20 is normally open, normally closed, or contains multiple parallel contacts such as one normally open and one normally closed. When the activator 36 is released and thus not depressed into the base unit 26, the sensor assembly 20 opposingly breaks and/or makes electrical contact to detect that the cam 24 is in the second position. In response to the depressed or released activator 36, the electronics unit within the base unit 26 informs a controller that the switch cam 24 is in the first position or the second position, and the controller can use that information to perform a desired function, for example activate or deactivate the child lock of the automotive vehicle. The sensor assembly 20 can also be designed to detect movement of the switch cam 24 between the first position and the second position, or vice versa, rather than the absolute position. In this case, it may be necessary to separately keep track of the current position of the switch cam 24.

As mentioned above, in addition to functioning as a switch by engaging the activator 36 of the sensor assembly 20, the improved sensor arm 22 also functions as a spring biasing the switch cam 24 to the desired position. When the cam 24 is disposed in the first position, as shown in FIGS. 1-3, the sensor arm 22 biases the cam 24 against the first segment 30 of the sensor arm 22, and the biasing force provided by the sensor arm 22 maintains the cam 24 in the first position until the cam 24 is intentionally moved to the second position. When the cam 24 is moved to the second position, as shown in FIGS. 4-6, the sensor arm 22 biases the cam 24 against the second segment 34 of the sensor arm 22, and the biasing force provided by the sensor arm 22 maintains the cam 24 in the second position until the cam 24 is intentionally moved back to the first position. As discussed above, when the cam 24 is in the first position, referred to as the depressed or unlocking position, the cam 24 presses the sensor arm 22 into the activator 36, and the activator 36 typically stays depressed until the cam 24 is moved out of the first position. When the cam 24 is in the second position, referred to as the released or locking position, the cam 24 and the sensor arm 22 release the activator 36, and the activator 36 typically stays released until the cam 24 is moved out of the second position.

The sensor assembly 20 with the improved sensor arm 22 shown in FIGS. 1-6 is used in a power actuated child lock system. However, the sensor assembly 20 could alternatively be used in another power actuated system, or a mechanical system. In the example embodiment shown in FIGS. 1-6, the power actuated child lock system is used in an automotive vehicle, and the sensor assembly 20 is disposed in a housing 38 located inside a door of the vehicle. The example system also includes an auxiliary lever 40 and lever inside release 42. In the unlocking position, the auxiliary lever 40 and lever inside release 42 are coupled to one another by a link 46. In the child locking position, the auxiliary lever 40 and lever inside release 42 are not coupled to one another. The lever inside release 42 is also coupled to an inside handle of the vehicle, typically the handle of a back door where a child may be located, by a cable 52. The system also comprises a sector 44 including the switch cam 24 and a motor 48 with a worm 50 for driving the sector 44 and the switch cam 24 to the desired position.

In FIGS. 1-3, the system is shown with the child lock off, in which case the auxiliary lever 40 and lever inside release 42 are coupled to one another by the link 46, and the sector 44 with the cam 24 are in the first position, also referred to as the unlocking position. In the unlocking position, pulling the interior handle on the back door of the vehicle will cause the cable 52 to rotate the lever inside release 42 counterclockwise, which in turn causes the auxiliary lever 40 to release the door latch. If a driver of the vehicle decides to enable the child lock, the driver typically presses a button on the interior of the vehicle to activate the motor 48. The worm 50 of the motor 48 then drives the switch cam 24 from the depressed position shown in FIGS. 1-3 to the released position, also referred to as the child locking position, shown in FIGS. 4-6. The electronics unit of the sensor assembly 20 detects that the switch cam 24 has moved to the child locking position and thus informs the controller, which then decouples the auxiliary lever 40 from the lever inside release 42. Thus, in the child locking position, if a child attempts to open the back door of the vehicle, the cable 52 will still rotate the lever inside release 42 counterclockwise, but the auxiliary lever 40 will not release the door latch.

As discussed above, the sensor arm 22 biases the cam 24 to the desired position, either the unlocking position or the child locking position, which depends on whether the child safety lock has been activated or deactivated by the user. The sensor arm 22 also reliably maintains the cam 24 in the desired position and prevents the cam 24 from unintentionally slipping or bouncing back from one position to the other. The electronics unit of sensor assembly 20 detects the position of the cam 24, either the unlocking position or the locking position, based on the position of the activator 36 and can then inform the controller to activate or deactivate the child lock of the automotive vehicle, for example by coupling or decoupling the auxiliary lever 40 and lever inside release 42. The sensor assembly 20 can also provide feedback to the controller regarding the position of the motor 48. In another embodiment, the sensor assembly 20 also provides feedback to the motor 48, for example feedback which instructs the motor 48 to stop moving.

The sensor assembly 20 with the improved sensor arm 22 provides for more reliable detection of the position of the cam 24, which indicates whether the child safety lock is activated by the user. The accurate position of the switch cam 24 is detected by the electronics unit of the sensor assembly 20 and provided to the controller, which in turn activates or deactivates the child lock in a reliable manner.

As discussed above, the sensor assembly 20 with the improved sensor arm 22 can be used in any type of power actuated system. The sensor assembly 20 can also be used in any type of latch or non-latch application, such as those disclosed in International Application Publication Number WO 2009/030046, US Patent Application Publication Nos. 2014/0028036 and 2009/0288506, and U.S. Pat. No. 8,141,916, each of which are incorporated herein by reference in their entirety.

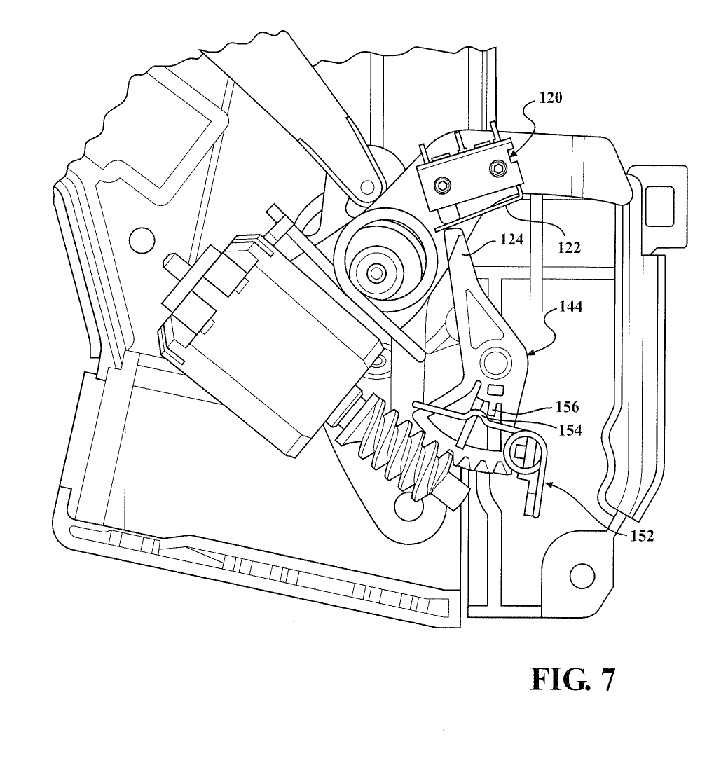

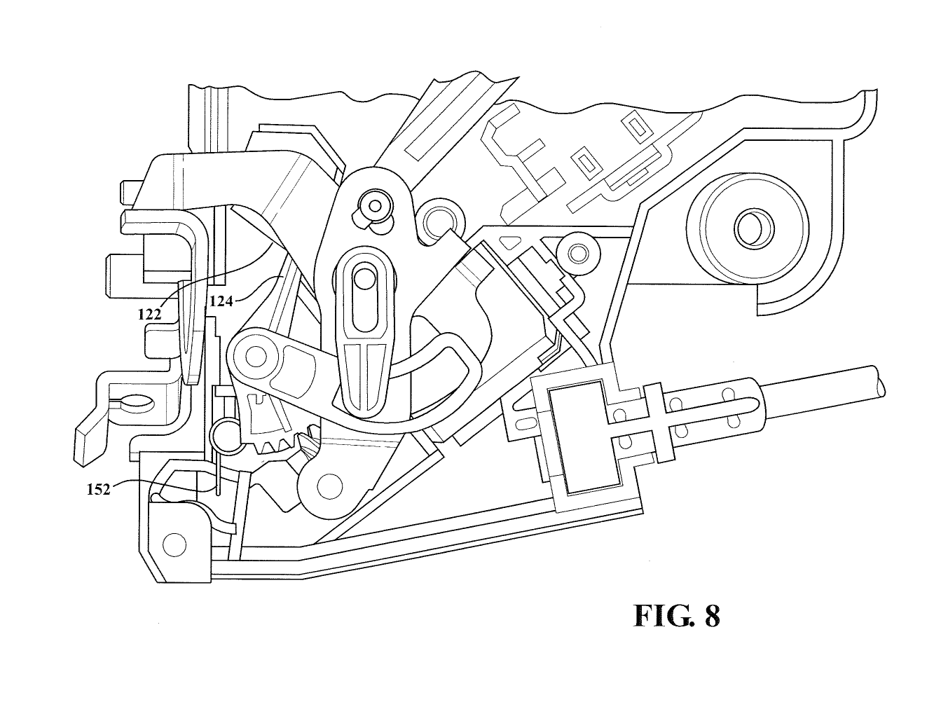

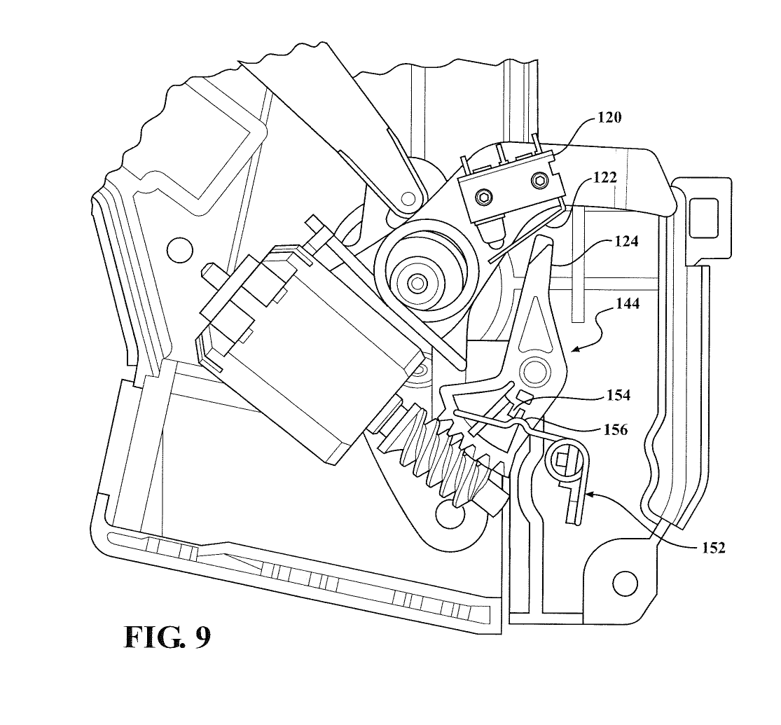

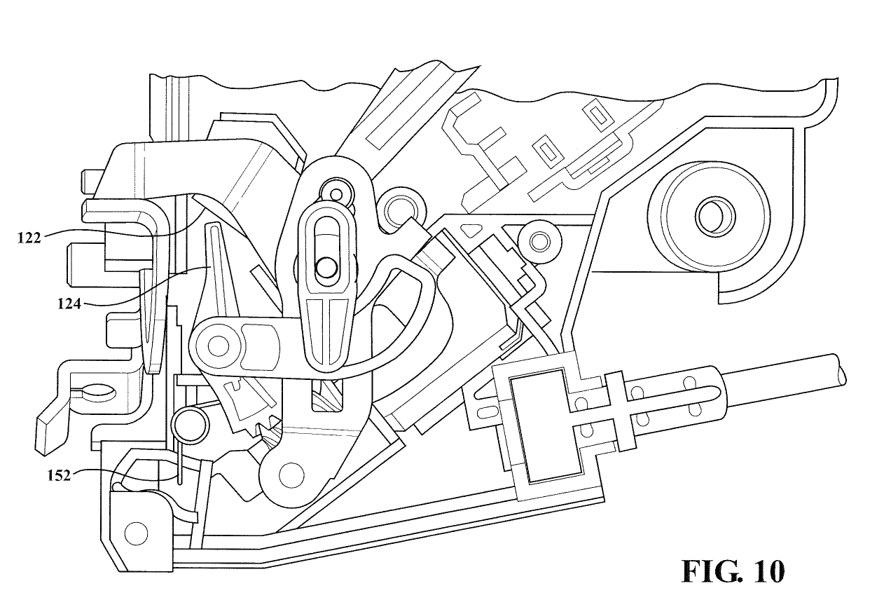

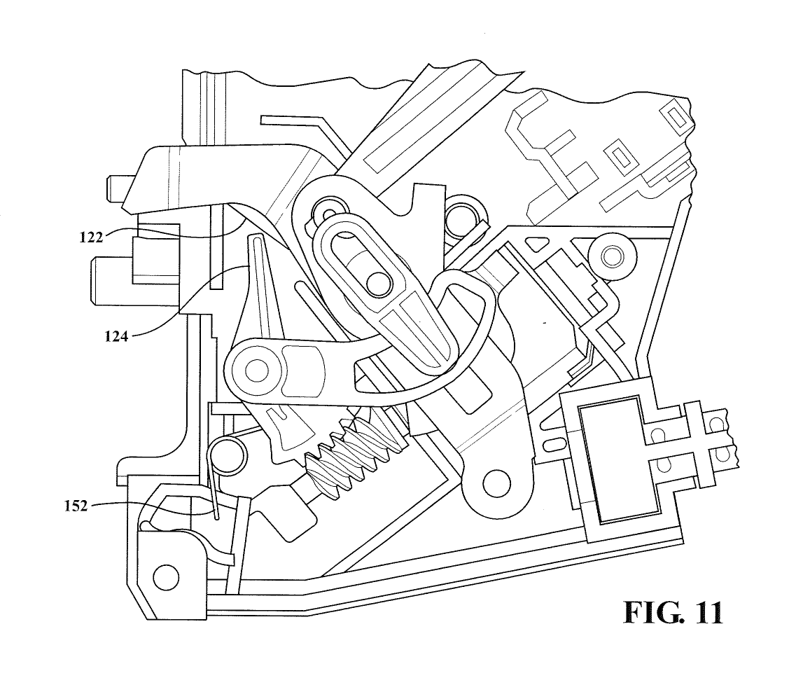

The sensor assembly 20 with the improved sensor arm 22 can also be used in a comparative child lock system including a sensor 120, as shown in FIGS. 7-11, in place of a planar sensor arm 122 and toggle spring 152. In this comparative system, the toggle spring 152 includes a bump 154 engaging a protrusion 156 of the sector 144 and biasing the switch cam 124 to either the first position or the second position. However, over time, the toggle spring 152 can deform or fail to operate as desired, potentially allowing the cam 124 to unintentionally slip to the undesired position or bounce back from one position to the other. The improved sensor arm 22, however, can be used in place of both the planar sensor arm 122 and the toggle spring 152 to provide a more reliable system.

Many modifications and variations to the above embodiments, and alternate embodiments and aspects are possible in light of the above teachings and may be practiced otherwise than as specifically described while falling within the scope of the claims.

What is claimed is:

1. A sensor assembly, comprising:
a base unit containing an activator, said activator extending outwardly from said base unit and being movable relative to said base unit;
a sensor arm formed of a resilient material and extending from said base unit to a distal end, said sensor arm including a first segment and a second segment, said first segment extending from said distal end over said outwardly extending activator, and said second segment extending from said first segment to said base unit; and
a switch cam engaging said sensor arm, said switch cam being movable along said sensor arm between said first segment and said second segment, wherein said switch cam presses said sensor arm and said activator to a depressed position when said switch cam engages said first segment, and said switch cam allows said first segment and said activator to move to a released position when said switch cam engages said second segment.

2. The sensor assembly of claim 1, wherein said sensor arm biases said switch cam to maintain said switch cam along said first segment after said switch cam is moved to said first segment, and said sensor arm biases said switch cam to maintain said switch cam along said second segment after said switch cam is moved to said second segment.

3. The sensor assembly of claim 1, wherein said sensor arm includes an apex joining said first segment and said second segment.

4. The sensor assembly of claim 3, wherein said first and second segments are straight.

5. The sensor assembly of claim 3, wherein said first and second segments are curved.

6. The sensor assembly of claim 1 further including a motor moving said switch cam along said first segment and said second segment of said sensor arm.

7. The sensor assembly of claim 1 further including an electronics unit disposed in said base unit and in communication with said activator, wherein said electronics unit detects the position of said switch cam based on the position of said activator.

8. The sensor assembly of claim 7, wherein said electronics unit conveys the position of said switch cam to a controller.

9. The sensor assembly of claim 8, wherein said controller activates or deactivates a latch in response to the position of said switch cam conveyed to said controller by said electronics unit.

10. The sensor assembly of claim 1, wherein said sensor arm is a leaf spring.

11. The sensor assembly of claim 1 further including an auxiliary lever, a lever inside release, and a link for coupling said auxiliary lever to said lever inside release when said switch cam engages said first segment of said sensor arm;
a motor for moving said switch cam along said sensor arm from said first segment to said second segment;
a housing surrounding said base unit, said sensor arm, said auxiliary lever, said lever inside release, said link, and said motor;
an electronics unit disposed in said base unit and in communication with said activator, wherein said electronics unit detects the position of said switch cam based on the position of said activator;
wherein activation of said motor causes said motor to move said switch cam along said sensor arm to said second segment, said electronics unit conveys the position of said switch cam along said second segment to said controller, and said controller decouples said auxiliary lever from said lever inside release in response to the positon of said switch cam.

12. A power actuated lock system, comprising:
a base unit containing an activator, said activator extending outwardly from said base unit and being movable relative to said base unit;
a sensor arm formed of a resilient material and extending from said base unit to a distal end, said sensor arm including a first segment and a second segment, said first segment extending from said distal end over said outwardly extending activator, and said second segment extending from said first segment to said base unit;
a switch cam engaging said sensor arm, said switch cam being movable along said sensor arm between said first segment and said second segment, wherein said switch cam presses said sensor arm and said activator to a depressed position when said switch cam engages said first segment, and said switch cam allows said first segment and said activator to move to a released position when said switch cam engages said second segment; and
a motor for moving said switch cam along said sensor arm from one of said segments to the other segment.

13. The power actuated system of claim 12, wherein said sensor arm biases said switch cam to maintain said switch cam along said first segment after said switch cam is moved to said first segment, and said sensor arm biases said switch cam to maintain said switch cam along said second segment after said switch cam is moved to said second segment.

14. A child lock system for a vehicle, comprising:
a base unit containing an activator, said activator extending outwardly from said base unit and being movable relative to said base unit;
a sensor arm formed of a resilient material and extending from said base unit to a distal end, said sensor arm including a first segment and a second segment, said first segment extending from said distal end over said outwardly extending activator, and said second segment extending from said first segment to said base unit;
a switch cam engaging said sensor arm, said switch cam being movable along said sensor arm between said first segment and said second segment, wherein said switch cam presses said sensor arm and said activator to a depressed position when said switch cam engages said first segment, and said switch cam allows said first segment and said activator to move to a released position when said switch cam engages said second segment;
a motor for moving said switch cam along said sensor arm from one of the segments to the other segment;
an electronics unit disposed in said base unit and in communication with said activator, wherein said electronics detects the position of said switch cam based on the position of said activator and conveys the position of said switch cam to a controller; and
said controller activates or deactivates a child lock in response to the position of said switch cam conveyed to said controller by said electronics unit.

15. The child lock system of claim 14, wherein said sensor arm biases said switch cam to maintain said switch cam along said first segment after said switch cam is moved to said first segment, and said sensor arm biases said switch cam to maintain said switch cam along said second segment after said switch cam is moved to said second segment.
